(19) United States
(12) Patent Application Publication
(10) Pub. No.: US 2004/0259429 A1
(43) Pub. Date: Dec. 23, 2004

(54) Connector body

(76) Inventors: Chang Sing Chu, Taoyuan Hsien (TW); Wen Lung Hsu, Taoyuan Hsien (TW)

Correspondence Address: RABIN & BERDO, P.C., Suite 500, 1101 14 Street, N.W., Washington, DC, 20005, US

(21) Appl. No.: 10/796,079

(22) Filed: Mar. 10, 2004

(30) Foreign Application Priority Data
Jun. 20, 2003 (TW) 092211322

(51) Int. Cl. H01R 13/648

(52) U.S. Cl. 439/745

(57) ABSTRACT

A connector body comprising a plastic housing with a central pillar shape connector and a spring arm ground connector; the central pillar shape connector consists of a central pillar and a solder part; the central pillar is a solid body with a compression part and a round head; the solder part is in “L” shape with a round hole, the round hole connects to the compression part of the central pillar firmly together into one piece; the mold is simple for lower manufacturing cost and higher efficiency of manufacturing, the product has better competition.

### BACKGROUND OF THE INVENTION

I. Field of the Invention

This invention relates generally to a small appliance DC power connector body and, more specifically, to a connector body having a plastic housing, a central contact and a spring arm. The central contact has a strong mechanical strength, both in vertical and horizontal directions, low manufacturing cost as well as higher efficiency of manufacturing.

II. Description of the Prior Art

Heretofore, it is known that the connector body is a plastic housing with a central contact and a spring arm. The central contact is inside the plastic housing insertion hole and said spring arm is installed into the insertion hole through the plastic housing. The plug is inserted into the connector body, the central contact will transmit the DC power into the electrical device.

It is known that central contacts are made from metal sheet by cutting and bending. The central contact and solder part are formed in one body and the center of the central contact is hollow. Not only the roundness of the hollow central contact is not easy to control but also the vertical, horizontal stress is not so strong. Thus the central contact would be deformed during insertion. Moreover, the prior central contact of the connector body are made in a single process, the tooling is complicated and expensive, and manufacturing cost is very high, but the yielding rate is quite low.

### SUMMARY OF THE INVENTION

It is therefore a primary object of the invention to provide a connector body that splits the central contact into two components with strong mechanical strength both in vertical and horizontal directions, and the duty life, mold, and manufacturing will be improved.

In order to achieve the objective set forth, a connector body in accordance with the present invention comprises a plastic housing with a central contact and a spring arm. The central contact is split into a central pillar, a solid body with a compression part on back and a round head, and a solder part, “L” shape with a round hole which holds the compression part of the central contact firmly makes them join together as one.

Accordingly, the central contact is solid and formed by a single body with strong mechanical strength both in vertical and horizontal directions, therefore, the product life, the product competition, the mold and the efficiency of manufacturing will be improved.

### BRIEF DESCRIPTION OF THE DRAWINGS

To accomplish the above-mentioned object, the present invention illustrates an embodiment by the following description and its accompanying drawings.

FIG. 1 is an assembly view of the present invention;

FIG. 2 is a cross-sectional view of the present invention;

FIG. 3 is a perspective of the present invention.

### DESCRIPTION OF THE PREFERRED EMBODIMENT

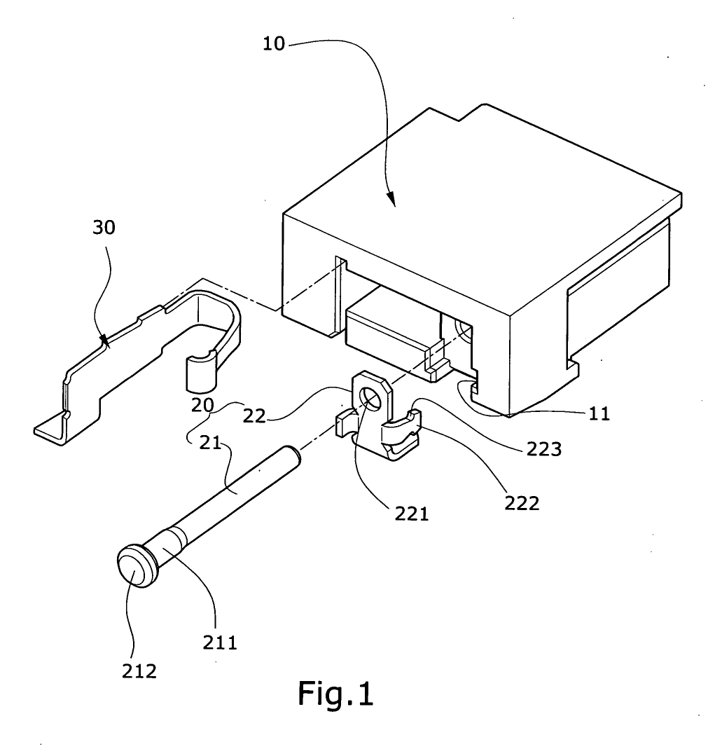

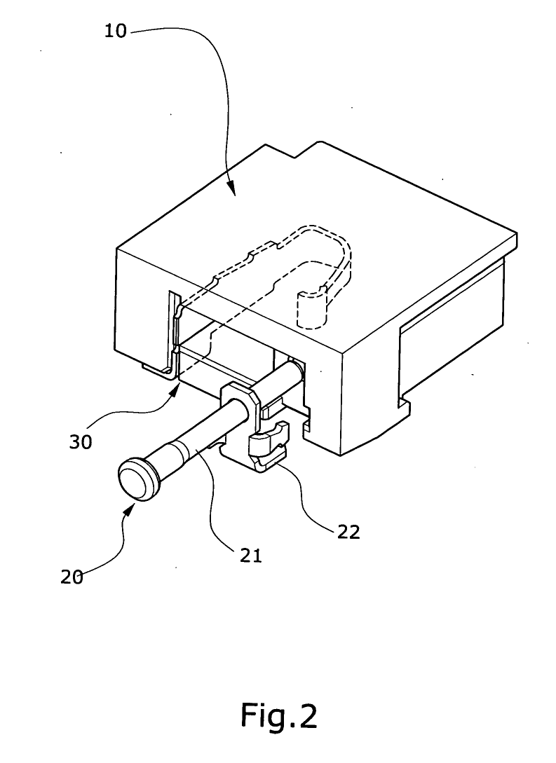

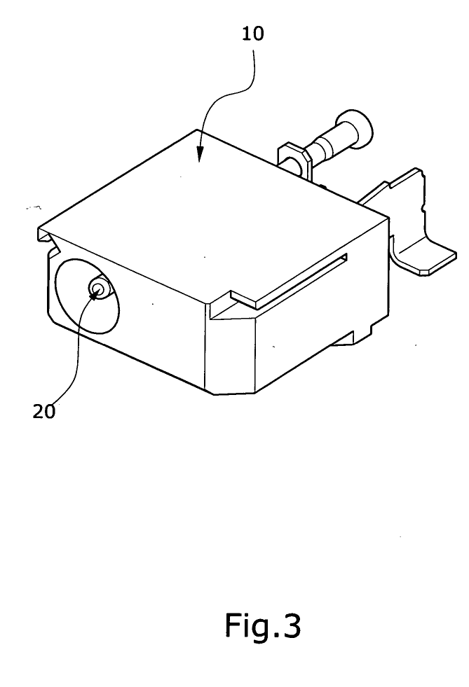

Referring to FIG. 1 to FIG. 3, the present invention comprises a plastic housing 10 with a central contact 20 and a spring arm 30.

The central contact 20 further consists of a central pillar 21 and a solder part 22; the central contact 20 is a solid body with a compression part 211 on back and a round head 212. The solder part 22 is in “L” shape with a round hole 221 while the round hole 221 thereof holds the compression part 211 of the central pillar 21 firmly together into one piece.

In assembly, the central pillar 21, at least part of it, stabs into the round hole 221 of the solder part 22 and has a round head 212 on back of the central pillar 22 propped up the back of the solder part 22 to combine the central pillar 21 and the solder part 22 firmly together. Then the central pillar contact 20 and the spring arm 30 are assembled and inserted into the plastic housing 10 from back. The central pillar 21 is a solid round pillar body and is formed in a single body with strong mechanical strength, both in vertical and horizontal directions, and the duty life is longer. The central pillar shape connector 20 only consists of two parts, so that the mold is simple for lower manufacturing cost and higher efficiency of manufacturing.

Based on the structure described above, a fastener 222 is bent forwardly approximately 90° and has hooks 223 protruding out two, upper and lower, sides of the fastener 222. After the central contact 20 is assembled into the plastic housing 10, the fastener 222 of the solder part 22 will be pushed into said corresponding fastener slot 11 at rear of the plastic housing 10, and the hooks 223 will interfere with the fastener slot 11 for grasping the fastener 222 inside the fastener slot 11.

While a preferred embodiment of the invention has been shown and described in detail, it will be readily understood and appreciated that numerous omissions, changes and additions may be made without departing from the spirit and scope of the invention.

What is claimed is:

1. A connector body comprising:
a plastic housing;
a central contact having a central pillar and a solder part,
wherein said central pillar is a solid body with a compression part on the back and a round head; said solder part is in “L” shape with a round hole and said round hole grasp the compression part of said central pillar firmly.

2. The connector recited in claim 1, wherein said housing has at least a fastener slot, and said fastener is bent forward in 90° for fitting into said fastener slot.
